(19) United States
(12) Patent Application Publication
(10) Pub. No.: US 2010/0014542 A1
(43) Pub. Date: Jan. 21, 2010

(54) NETWORK PROCESSING APPARATUS AND PROCESSING METHOD THEREOF

(75) Inventor: Hiroyoshi Ooshima, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/501,407

(22) Filed: Jul. 11, 2009

(30) Foreign Application Priority Data
Jul. 18, 2008 (JP) 2008-187913
May 26, 2009 (JP) 2009-126822

(51) Int. Cl. H04J 3/24

(52) U.S. Cl. 370/474

(57) ABSTRACT

A network processing apparatus that receives a fragmented IP datagram to perform reassembling process of the received fragmented IP datagram. Information is held regarding the received IP datagram in which the reassembling process is terminated. Upon performing the reassembling process, in a case where an IP datagram specified by the held information is received, the reassembling process of the IP datagram is not performed.

### BACKGROUND OF THE INVENTION

1. Field of the Invention

The present invention relates to a reassembling process of received fragmented IP datagram.

2. Description of the Related Art

Conventionally, as a part of the network protocol process, a reassembling process of a fragmented IP datagram is conducted. A method of the fragmenting process and a method of the reassembling process are described in RFC791 “Internet Protocol”.

In IP datagram receiving unit, when the fragmented datagram is received, aforementioned IP datagram reassembling process is started. Since, the specific reassembling process is described in aforementioned RFC791; a detailed explanation of the process is omitted.

Conventionally, when sending an IP datagram, if the datagram is larger than the assigned datagram size of the communication path, the datagram is fragmented by the sending unit. The sending unit is not always a source unit, it also includes intermediate units (routers) existing in the communication path.

The intermediate unit conducts the role of analyzing an IP datagram, once the IP datagram is received, and then the role of retransmitting it to an appropriate path. Then, similar to the sending unit, at the time of sending, if necessary fragmenting process is conducted on the IP datagram and then transmitted it into the appropriate path.

Moreover, the intermediate unit conducts the selection of appropriate path, arrival guarantee and etc. Several algorithms is been used for conducting these functions. Among them, algorithms for transmitting the IP datagram into multiple different paths simultaneously and algorithms for resending the same IP datagram a plurality of times, exist. Therefore, the arrived fragmented IP datagram set might not just arrive out of order, additionally; payload of the fragmented IP datagram may have been partially or totally replicated. Moreover, there are times the datagram set is arriving within a relatively limited time interval as well as there are times a part of datagram set is arriving after a predefined time interval. Please refer to the Japanese Patent Laid-Open NO. 2004-180253 for more details.

As discussed above, at the IP datagram receiving unit, when fragmented IP datagram is received, resource for reassembling process is allocated. However, when there are intermediate units on the communication path, some IP datagram (replicated) keep on arriving after the reassembling process is already conducted.

Also, part of the fragmented IP datagram set may arrive after the corresponding reassembling process is been timed out and resource is released.

When such cases arise, once again resources get allocated by the receiving unit, because it starts the reassembling process again. However, in above mention cases, completion of the aforementioned reassembling process is mostly improbable. In other words, the resources get allocated until it is timed out for some highly improbable reassembling processes.

This resource loss, become a reason for resource drain, and as a result the receiving unit may have to discard newly received IP datagram without reassembling. Especially, in embedded systems with limited memory resources, influence of the above mentioned resource loss become high.

On the other hand, adding multiple number of resources that enable simultaneous reassembling process, might enable overcoming above problem, however, such a solution may be highly expensive.

### SUMMARY OF THE INVENTION

The present invention provides an apparatus and a method that can reduce the resource drain when conducting reassembling process of fragmented IP datagram.

According to one aspect of the present invention, there is provided a network process apparatus comprising: a processing unit that receives a fragmented IP datagram to perform a reassembling process of the received I1 datagram; and a holding unit that holds information for specifying the IP datagram which is not subjected to the reassembling process, wherein the processing unit does not perform reassembling process of the IP datagram specified by the information held in the holding unit.

According to another aspect of the present invention, there is provided a processing method of a network processing apparatus comprising: receiving a fragmented IP datagram to perform reassembling process of the received IP datagram, and holding information for specifying the IP datagram in which the reassembling process is not performed, wherein, in a case where an IP datagram specified by the information held in the holding step is received, the reassembling process of the IP datagram is not performed.

Further features of the present invention will become apparent from the following description of exemplary embodiments (with reference to the attached drawings).

### BRIEF DESCRIPTION OF THE DRAWINGS

FIG. 1 is a block diagram that shows an exemplary architecture of the network protocol processing unit according to the first embodiment;

FIG. 2 shows a data construction of RAM103;

FIG. 3 shows details of Management Entries stored in reassembling process management table 202 which undergoing the reassembling process;

FIG. 4 shows details of a bit table which is stored in the bit table area 203;

FIG. 5 shows details of a reassembling buffer stored in the reassembling buffer area 204;

FIG. 6 is a flowchart that represents the initialization of the reassembling process;

FIG. 7 is a flowchart that represents the normal flow of the reassembling process;

FIG. 8 is a flowchart that represents the ending of the reassembling process;

FIG. 9 is a flowchart that represents the IP datagram receiving process according to the first embodiment; and

FIG. 10 is a flowchart that represents the IP datagram receiving process according to the second embodiment.

### DESCRIPTION OF THE EMBODIMENTS

Hereinafter, preferred embodiments of the present invention will be described in detail with reference to the accompanying drawings.

### The First Embodiment

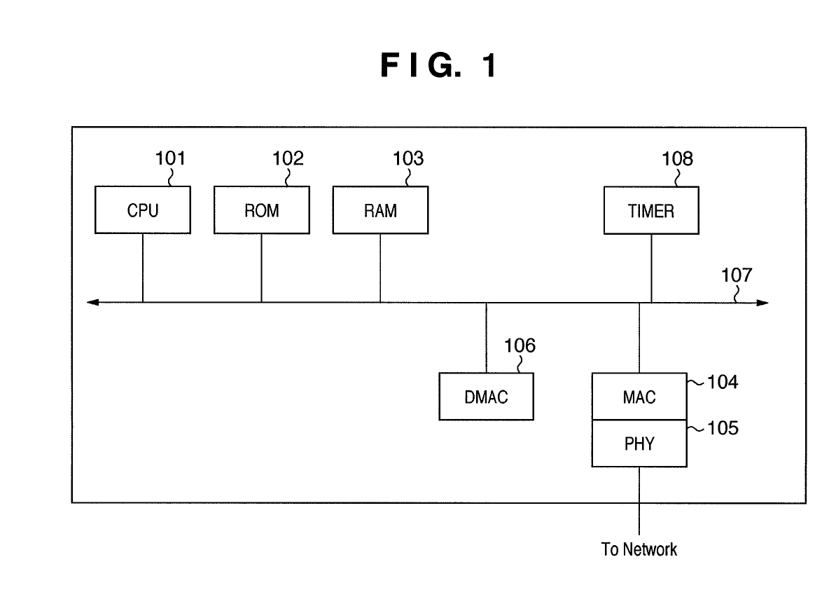

FIG. 1 is a block diagram that shows an exemplary architecture of the network protocol processing unit according to the first embodiment. In FIG. 1 a CPU 101, according to a control program (software) stored in ROM which will be discussed later, conducts network protocol processing. The software executed by the CPU 101 is stored in a ROM 102. The CPU 101 uses a RAM area 103 as a working area while executing protocol processing.

MAC (Media Access Control) 104 is a part of communication protocol in the data link layer, which corresponds to the second layer of the OSI reference model. PHY (Physical Layer) 105 is the hardware that handles electronic signals which corresponds to the first layer of the OSI reference model. DMAC (Direct Memory Access Control) 106 coordinates the data transmitted between the RAM 103 and the RAM 104 when TCP/IP network communication is conducted. Path 107 interconnects the CPU 101, the ROM 102, the RAM 103, the MAC 104, and the DMAC 106.

Timer 108 provides the simultaneous timing for a plurality of timers (as examples: reassembling time, resending time) which is needed for protocol processing.

Here, in general RAM 103 is realized using inexpensive DRAM (Off-chip), it may realize also with relatively fast On-chip SRAM. However, On-chip SRAM is expensive. Because of this reason, providing SRAM for the total size of the RAM 103 according to the present embodiment may be difficult. In such a case, realizing the RAM 103 by combining inexpensive but relatively slow DRAM with relatively fast but expensive SRAM can be conducted.

In other words, the frequently accessed data and data that can influence the protocol processing efficiency should be stored in the high speed on-chip SRAM and the rest of data should be stored in DRAM. Therefore, in present embodiment, implementation can be conducted with DRAM or/and on-chip SPAM or other recording media. Therefore, all these collectively referred as the RAM 103.

Here, the RAM 103 is not only used as a working area of the CPU 101, it is also used as an area for storing necessary data for TCP/IP network protocol processes. These data includes the data sent and received in TCP/IP communication, Fragment Block Bit Table data and etc.

Here, a Fragment Block Bit Table is called a bit table and an information table for managing the Fragment Block Bit Table is called a management table. Moreover, the management information of each Bit Table that is stored in the management table is called a management entry. The Bit Table is also called as a Bit Map Table.

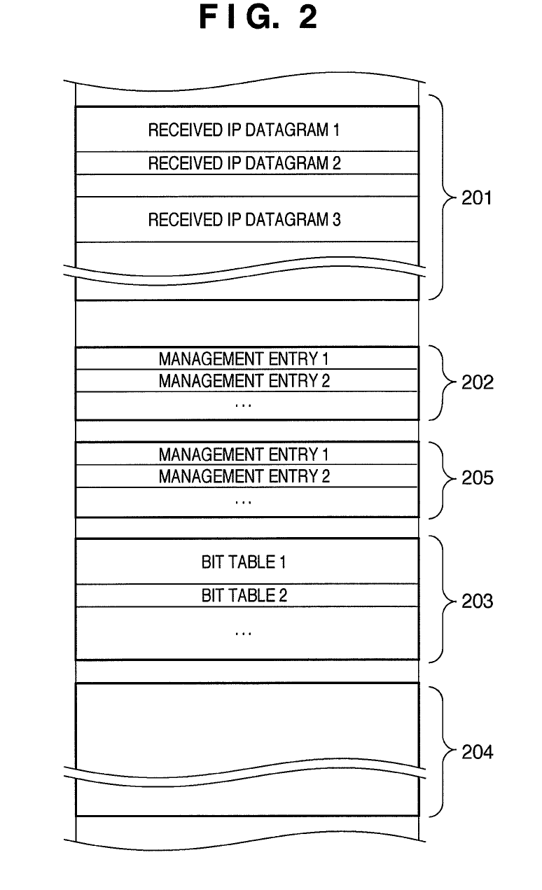

FIG. 2 shows a data construction of RAM 103. In FIG. 2 only the data necessary for explaining the present invention is represented, the data in RAM 103 that is required for the protocol processing is not represented. As an example of the unrepresented data are the data such as working data of the CPU 101, and sent IP datagram.

In FIG. 2, the received IP datagram is once stored in the received data area 201. The reassembling process management table 202 that undergoing the reassembling process, stores the management entry which contains the management information of each bit table. The management entry, with the corresponding bit table, mostly generated when reassembling process is started, and preserve the IP datagram information until the process is ended.

The bit table itself is stored in the bit table area 203. All the bit tables has a one to one correspondence with predefined management entries. In reassembling buffer area 204, the payload of the IP datagram undergoing the reassembling process is stored.

The non-reassembling process management table 205 stores the management entries which are the management information of IP datagram that are not undergoing the reassembling process. In the non-reassembling process management table 205, IP datagram information of the reassembling processes that have already ended and the reassembling processes that have timed-out are stored for a limited time interval. Regarding the details of method of using these management data and regarding the details of recording time and deleting time will be discussed later.

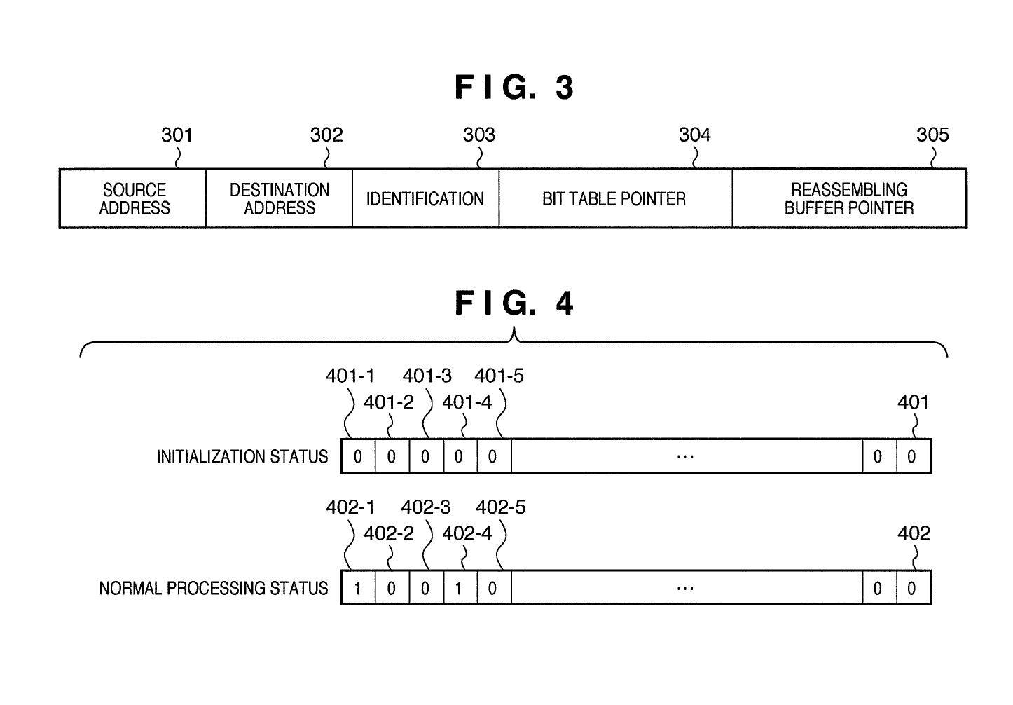

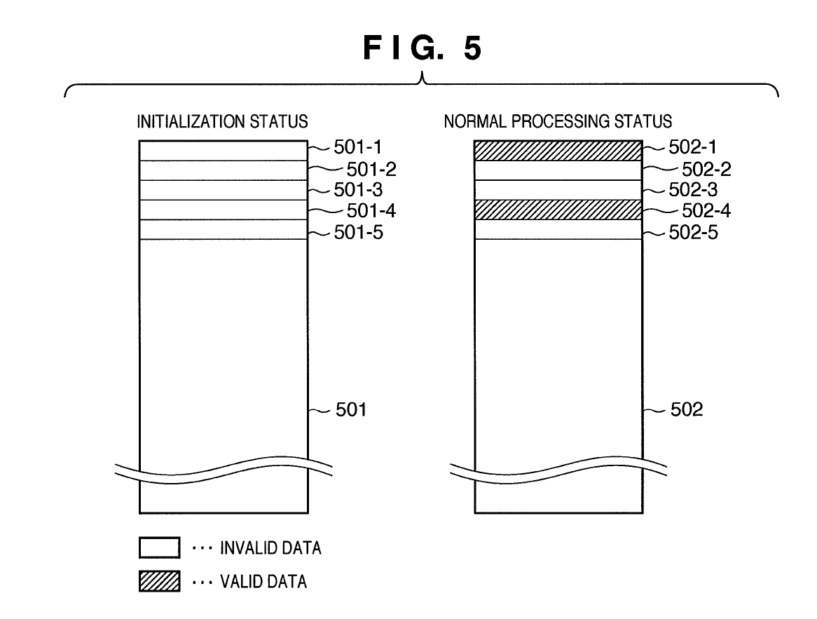

Next, the relationships between the management entry within the reassembling process management table 202, bit table within the bit table area 203, and the reassembling buffer within the reassembling buffer area 204 are explained while using FIG. 3≠FIG. 5.

FIG. 3 shows details of the management entries stored in reassembling process management table 202 which is undergoing the reassembling process in FIG. 3, 301 is a source address, which matches with the IP address stored in a Source Address Field of the received IP header. Similarly, 302 is a destination address, which matches with the IP address stored in a Destination Address Field of the received IP header. Again similarly, 303 is an Identification, which matches with an identification in the Identification Field of the received IP header.

The source address 301, the destination address 302 and the identification 303 are used for specifying the IP datagram undergoing the reassembling process. Because, in case the IP datagram is fragmented by a source unit or by routers, these fields belonging to the original IP datagram are copied in to the fields of newly created IP datagram after the fragmentation.

Therefore, at the receiving unit, when there are IP datagram with the same three fields, they should be reassembled together, and for the IP datagram which has not matching fields, they should be reassembled separately.

In the present embodiment, conducting reassembling process in parallel for a plurality of IP datagram is considered. Here, management entry contains the information of three fields, to identify reassembling process where the associated IP datagram is been used.

In FIG. 3, 304 is a Bit Pointer, which is used for indicating the address information of the bit table area 203 associated with aforementioned management entry. 305 is a Reassembling Buffer Pointer which is used for indicating the address information of the reassembling buffer area 204 associated with aforementioned management entry.

FIG. 4 shows details of a bit table which is stored in the bit table area 203. In FIG. 4, 401 is the Bit Table Initialization state, 402 is the state where the Bit Table is conducting the reassembling process. Bit Table bit 401-1≠401-5, 402-1≠402-5 represents whether payload data is received or not, when “1” is set the payload data is received. In contrast, when “0” is set, not receiving the payload data is represented. Also, at the time the Bit Table is initialized, all the bits are set to “0”, since none of the payload is received yet.

FIG. 5 shows details of a Reassembling Buffer stored in the Reassembling Buffer area 204. In FIG. 5, 501 is the Reassembling Buffer Initialization state and all the data invalid state is been represented. 502 is the state where the Reassembling Buffer is functioning, buffers correspond to the bit table 402 shown in FIG. 4 which has already received and stored the data. In other words, Reassembling Buffer unit areas 501-1≠501-5, 502-1≠502-5 represents each payload data storing areas and in case each corresponding Bit Table denote that data has been already received, it indicates that the payload data has already received and then stored. In the initialization state, all the bits are set to “0”, since none of the payload data is been received. In this stage all the data in the reassembling buffer becomes invalid.

Bit Table's each bit represents 8 bytes which is the smallest fragment size. As an example, at the stage processing is conducted as represented in FIG. 4, the reason to set “1” in bit 402-1 is to represent, the first 8 bytes from the top of the payload of IP datagram before fragmenting is been received. In other words, the unit area 502-1 represented in FIG. 5 stores valid payload data.

Similarly, the reason to set “1” in bit 402-4 is to represent, the 8 bytes from the 24 offset byte from the top of the payload of IP datagram before fragmenting is been received. In other words, in the unit area 502-4 represented in FIG. 5 stores valid payload data.

On the other hand, the bit 402-2 which has “0” set represents that 8 bytes after a 8 byte offset form the top of the payload prior to fragmenting of the IP datagram is not been received. In other words, the unit area 502-2 represented in FIG. 5 stores invalid payload data. Similarly, unit area 402-3 and 402-5 also represent that each unit area has not yet receive the 8 byte data portion.

Here, the non-reassembling process management table 205 stores data similar to the management entry represented in FIG. 3 whether it is a non-reassembling IP datagram or not can be determination using the each information of the source address 301, the destination address 302, and the identification 303. However, due to ease of memory management, management entry itself has been used for this determination.

In the first embodiment, the discussion assumed that reassembling process management table 202 and non-reassembling process management table 205 are located in different memory areas; however, these may exist in the same memory area. In such case, management entry is managed with link list architecture; two link lists are created for management entry managing reassembling process table and management entry managing non-reassembling process data. Then, when new reassembling process is been started reassembling process conducting management entry is added to the list for reassembling process data, when the process is ended or timed out the management entry is deleted from the reassembling process list and moved to the non-reassembling process list.

Thus, process can be conducted with operations only on link list pointer, it can be conducted without copying or adjusting parts of data, in other words copying or adjusting the source address 301, destination address 302, and identification 303.

Moreover, as another management method setting up flags can be given. In other words, by setting a flag in management entry for conducting reassembling process or non-reassembling process, and based on the flag deciding whether it is a reassembling process or non-reassembling process can be conducted.

By using any of the methods discussed above, managing reassembling process management table 202 and non-reassembling process management table 205 in the same memory area is possible.

Therefore, in present invention as management information of the non-reassembling process having source address, destination address and identification is enough. Moreover, storing, managing management entry to RAM 103 can be conducted by any of the methods discussed above.

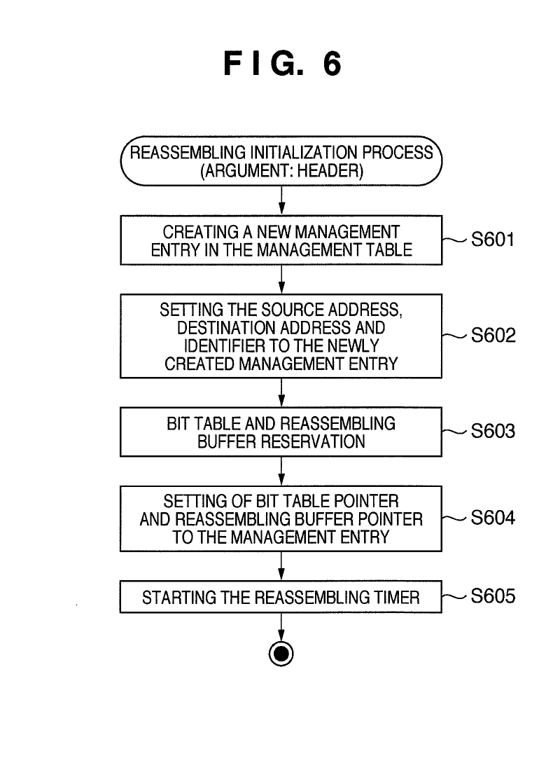

Next, management entry used in reassembling process, processes regarding Bit Table and Reassembling Buffer (reassembling initialization process, normal reassembling process, reassembling ending process) is been explained using FIG. 6 and FIG. 8. These processes are executed by the CPU 101.

<Reassembling Initialization Process (FIG. 6)>

FIG. 6 is a flowchart that represents the initialization of the reassembling process. Reassembling initialization process is started at the time reassembling process is started; however, receiving fragmented IP datagram is considered as a presumption. Moreover, the header information of the received IP datagram is passed as the argument (Header)

First, in step S601, CPU 101 creates a new management entry in the reassembling process management table 202. Next, in step S602, the source address 301, the destination address 302, and the identification 303 is set to the newly created management entry using the information of the argument Header (source address, destination address, and identification) received from the IP datagram.

Next, in step S603, memory is allocated and initialized for Bit Table and Reassembling Buffer at Bit Table area 203 and Reassembling Buffer area 204 respectively. Here, Bit Table initialization is conducted by setting every bit into “0” as represented in the Bit Table 401 shown in FIG. 4. Moreover, the validity and invalidity of data inside Reassembling Buffer is determined by the bits of the Bit Table, therefore, it is unnecessary to do anything for Reassembling buffer initialization.

After initialization, in step S604, the storing address of the Bit Table is set to the Bit Table Pointer 304 of the newly created management entry in step S601. Similarly, the storing address of Reassembling Buffer is set to the Reassembling Buffer Pointer 305.

Finally, in step S605, the timing for this reassembling process is started by requesting from the timer 108, and conclude the reassembling initialization process. Here, reassembling timer is a timer that conducts timing until the reassembling process is timed out.

Usually, before this timer is timed out, all the fragmented IP datagram are received and reassembling is concluded. However, in case part of the fragmented datagram is loss in the communication path for some reason, the reassembling cannot get concluded even in case it is waited for a long time. In such cases as above, when the time out period is passed at the timer, reassembling process is concluded and resource is been released which were assigned for aforementioned reassembling.

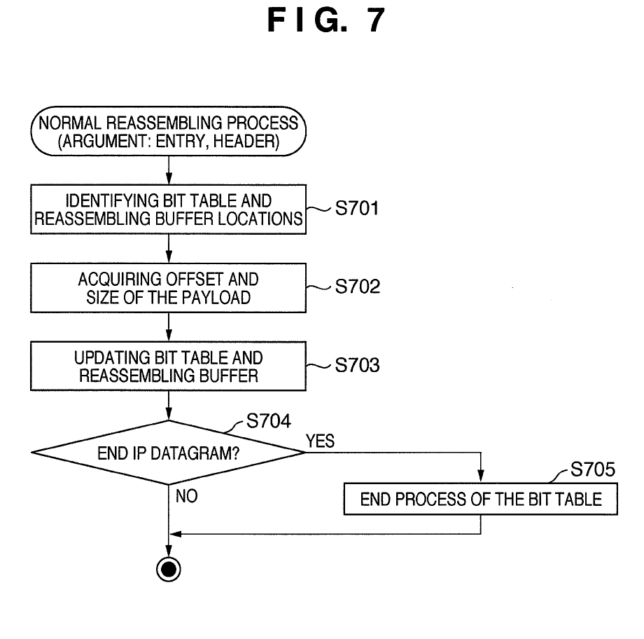

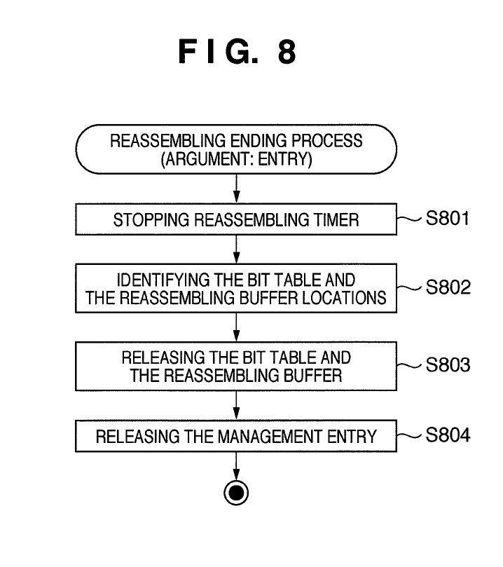

Moreover, when reassembling timer is timed out; it is notified to the CPU 101 by interrupt message. Using this notification CPU 101 identifies which timed out reassembling process is managed by which management entry. This identification method can have the construction of, as an example, uniformly linking to the notification method or first preserving the timed out information of the timer 108, then after the time out, the CPU 101 identifying the preserved information. Here, identification of the timed out management entry is sufficient and there is no limitation on the identification method.

<The Normal Reassembling Process (FIG. 7)>

FIG. 7 is a flowchart that represents the normal flow of the reassembling process. The reassembling process is conducted when fragmented IP datagram is received. Moreover, as discussed in detail later, to detect whether there is a management entry with matching information to the IP datagram header information at the time IP datagram is received, reassembling process table 202 is been searched. When there is a matching management entry as the search result, the IP header information of the received IP datagram, and the management entry is passed as parameters (Header, Entry) respectively. On the other hand when there is no matching management entry as the search result, a new management entry is created according to the reassembling initialization process (FIG. 6), then the management entry is passed as a argument (Entry).

First, in step S701, from the bit table pointer 304 and reassembling buffer pointer 305 of argument Entry, CPU 101 determines the associated Bit Table and the Reassembling Buffer. Then, in step S702, from the argument Header, Offset and payload size of the received IP datagram, which represent received payload location within the total payload and size of the received payload respectively, is obtained.

Here Offset is the value of the Fragment Offset field of the Header. Moreover, payload size is calculated using the IHL field and Total Length field of the Header. IHL field is the word (1 word=4 byte) number of the IP datagram, Total Length field is the total length (bytes) of the IP datagram. In other words, payload size can be calculated according the following equation.

Payload size (Byte)=Total Length field−(IHL field×4)

As an example, a case where Total Length field is 1044 byte, and IHL field is 5 considered; then from the following calculations payload size (1K byte) is calculated.

1044−(5×4)=1024 byte=1 Kbyte

After obtaining the Offset and the payload size, process-flow proceeds to step S703, updating process of the Bit Table and Reassembling Buffer determined in step S701, is conducted. The updating process of the Bit Table is conducted by setting the bit to “1” that corresponds to the received part of the payload from the payload data before fragmentation. As an example, a case where Offset is 0 (zero), and payload size is 24 byte is considered. In this case, “1” is set to the 3^{rd} bit of the Bit Table from the top. Then as the updating process of the reassembling buffer copying the payload data to the area that corresponding to the received payload data.

Next, in step S704, it is determined whether or not received IP datagram is an end—IP datagram. Specifically, it is determined whether MF (More Fragment) fag of the Header is “1” and if it is “1” since there are following fragments, the fragment is determine to be not a end—IP datagram. Moreover, if its “0” there are no following IP datagram and the datagram is considered to be an end—IP datagram.

In case it is determined to be an end—IP datagram in step S704, the process-flow proceeds to step S705 and bit table ending process is conducted. Specifically, all the bits below the bit corresponding to the received IP datagram are set to “1”.

Due this process, when all the bits of the bit table is set to “1”, all the fragmented IP datagram is being received, in other words, the reassembling process is been completed.

The end processing method is not limited to the above described method; it can be implemented with other methods. In other words, any method that can identify the completion of reassembling process can be used.

In case of end processing of Bit Table is conducted in step S705, even in case in step S704 the IP datagram is decided to be not an end—IP datagram, still the normal reassembling process is considered to be completed.

<Reassembling Ending Process (FIG. 8)>

FIG. 8 is a flowchart that represents the ending of the reassembling process. This reassembling ending process is executed when reassembling process is completed or timed out. Before stating this process the management entry that completed the reassembling process or timed out is been determined, which is been passed as an argument (Entry).

First, in step S801, CPU 101 instructs the timer 108 to stop the reassembling timer of aforementioned reassembling process. Specifically, it is the reassembling timer which was started at reassembling initialization process in step S605 of FIG. 6. Then, this reassembling timer is released and available for other reassembling processes to use.

Next, in step S802, from the Bit Table Pointer 304 and Reassembling Buffer Pointer 305 of management entry which has been passed as an argument (Entry), the stored location of corresponding Bit Table and the Reassembling Buffer are been determined respectively. Then, in step S803, the Bit Table area 203 allocated in step S802 is been released, and also release the reassembling buffer from reassembling buffer area 204. These released areas can be used freely after the release.

Finally, in step S804, the management entry of argument (Entry) is released from the reassembling process management table 202. With this step, the reassembling ending process is completed.

<The Reassembling Process of the First Embodiment>

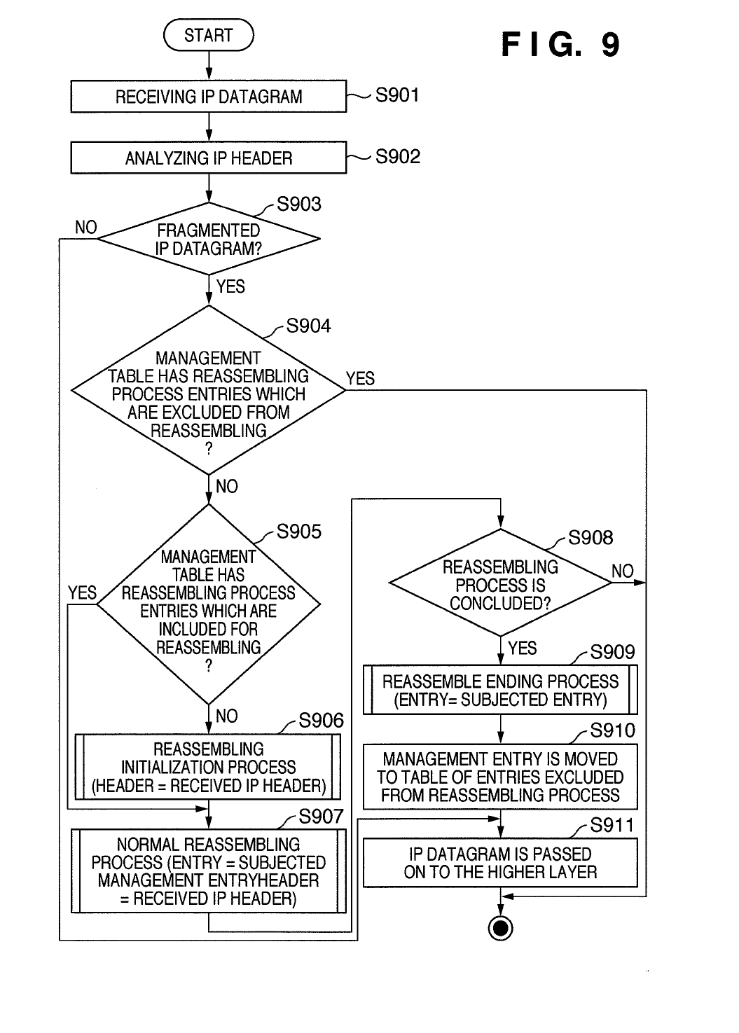

Here, the process flow of the protocol processing apparatus when the IP datagram is received, is described using FIG. 9. Here, this reassembling process is triggered by the CPU 101 in response to received IP datagram.

FIG. 9 is a flowchart that represents the IP datagram receiving process according to the first embodiment. First, in step S901, the IP datagram is received. The IP datagram is received from outside at MAC 104 through PHY 105. Thereafter, the data is forwarded via the bus 107 to the received data area 201 inside RAM 103 using the DMAC 106. Here, without using DMAC 106, CPU 101 may forward the received data to the received data area 201.

Next in step S902, the CPU 101 analyzes the header of the received IP datagram. Here, the IP datagram received in step S901 is called received-IP datagram; IP header of the received IP datagram is called received-IP header; and the payload of the received IP datagram is called the received-payload. Moreover, the IP datagram that contain the last part of the payload before fragmentized is called end-IP datagram.

Next, in step S903, based on the IP header analysis of step S902, it is determined whether the IP datagram is been fragmented or not. The determination is conducted using the More Fragment flag (ME flag) and the Fragment Offset field.

Specifically, first it is determined whether the MF flag is set (the case: “1”). In case the ME flag is set, the received IP datagram is not an end IP datagram. In case the ME flag is not set, the received IP datagram is not fragmentized or it is an end—IP datagram.

When ME flag is not set, additionally, the fragment offset field is been checked. In case the offset field is set to “0”, the received IP datagram has not been fragmentized. However, in case the fragment offset field is a value other than “0”, the received IP datagram is an end-IP datagram.

In case MF flag is set, received IP datagram is determined to be fragmentized. In case MF flag is not set and fragment offset field is set to a value other than “0”, the received IP datagram is determined to be fragmented. In case ME flag is not set and the fragment offset field is set to “0”, the received IP datagram is considered to be a normal datagram which has not been fragmentized.

In step S903, in case it is estimated that received IP datagram is been fragmentized, the process flow proceeds to step S904 and verifies whether there exist a management entry that matches received-IP header by searching the non-reassembling process management table 205. In other words, it is determined whether received-IP datagram is subjected or not subjected to the reassembling process. This is conducted by evaluating whether source address, destination address, and identification of the receive-IP header matches to source address 301, destination address 302, and identification 303 of corresponding management entry.

Here, in case there is a management entry that matches above three items, received IP datagram is not subjected to the reassembling process. In this case, the IP datagram receiving process is ended without conducting reassembling process. Here, IP datagram is deleted from the received data area 201, in other words received—IP datagram is discarded.

In the first embodiment, as explained in main reassembling process, there are also other processes conducted when IP datagram is received. The discarding of the received datagram means not conducting all or part of these processes corresponding to the received-IP datagram.

In step S904, when it is estimated to be a non-reassembling process, reassembling process corresponding to the received IP datagram is not executed, after that, it is not controlled whether IP datagram is discarded or not.

On one hand, when it is determined that it is a non-reassembling process in step S904, the process-flow proceeds to step S905. In step S905, reassembling process management table 202 is searched to find whether there is a matching management entry with the received IP header. Here, similar to step S904, it is evaluated whether source address, destination address, and identification of the receive-IP header matches to source address 301, destination address 302, and identification 303 of corresponding management entry.

Here, when there is no management entry that matches above three items, the reassembling process of the corresponding received IP datagram is not yet started. In other words, it represents the necessity of starting the reassembling process of the IP datagram with received IP header. Therefore, the process-flow proceeds to step S906, and executes the reassembling initializing process (FIG. 6). At this time, received IP header is passed to the argument Header (IP header). Then, after this reassembling initialization process (FIG. 6) is executed, the process-flow proceeds to step S907.

On the other hand, in step S905, in case there is a matching management entry to the received—IP header, reassembling process corresponding to the received—IP datagram is already started. Here, without executing the reassembling initialization process (FIG. 6), the process-flow proceeds to step S907 and executes the normal reassembling process (FIG. 7). In this case, management entry in the reassembling process management table 202 of the received IP datagram is provided as the argument Entry. Here, this management entry, in step S906, in case reassembling process (FIG. 6) is executed, is the newly created management entry in step S601. In case step S906 is been skipped, the management entry is the management entry matched in step S905. Moreover, received IP header is provided to the argument Header.

Next, in step S908, whether reassembling process completed or not, in other words, whether all the payload of fragmented IP datagram is received or not is verified. This process verifies whether all the bits in Bit Table corresponding to the present management entry is set to “1” or not. However, this is not limited to above flow, in case in step S705 (ending process of Bit Table) of the normal reassembling process (FIG. 7) the ending process of the Bit Table is not conducted.

Here, the ending process is setting all the bits to “1” which does not correspond to the received IP datagram. In any case, verifying whether reassembling process is concluded or not, can be conducted using the finishing process of normal reassembling process (FIG. 7) of step S705.

In step S908, in case it is determined that reassembling process is not completed, when ext IP datagram is received after completing this process, once again process of step S901 is executed. On the other hand, in step S908, in case it is determined that reassembling process is been concluded, the process-flow proceeds to step S909, and executes the reassembling ending process (FIG. 8). At this time, present management entry is provided to the argument Entry. As a result of this reassembling ending process (FIG. 8), management entry, the Bit Table corresponding to this management entry, and reassembling buffer is released and reassembling timer is stopped.

Next, in step S910, management entry of the reassembling process completed IP datagram is moved to the non-reassembling process management table 205. Here, moving represent normal copying operation, however, based on the architecture of the reassembling process management table 202 and non-reassembling process management table 205, it might become a different operation. In other words, as described above, in case both memory areas are existing in a single physical area in RAM 103 and managed by link list or identification flag, these other operations are conducted. In any case, after the end of the process of step S910, at the time the set of processes conducted when another IP datagram is received, the aforementioned management entry should be in the non-assembling process management table 205 so that it could be found when it is searched for, in step 5904.

Next, in step S911, after concluding the reassembling process, the previous payload is passed to the layer above. Here, also in case IP datagram is determined to be not fragmentized in step S903, in step S911 the payload data is passed to the above layer. Here, the above layer is, usually, a software program that conducts normal TCP processes, however it is not specifically limited in anyways in present embodiment.

Here, the procedures of the protocol processing apparatus, when the reassembling timer is timed out, is described. The protocol process apparatus execution of these procedures is triggered by the time out of reassembling timer.

Here, similar to the explanation of reassembling initialization process (FIG. 6), at the time the time out process is started, ability to specify the relevant management entry stored within the reassembling process management table 202 is a presumption.

First a specific reassembling timer is timed out and it is notified to the CPU 101. Simultaneously, the corresponding management entry that contains the information on timed out reassembling process is located by the CPU 101. Then, similar to the process in step S909 shown in FIG. 9, reassembling ending process (FIG. 8) is executed. Here, the argument Entry, receives management entry that contains the management information of timed out reassembling process. Next, similar to step S910, management entry of the reassembling process completed IP datagram is moved to the non-reassembling process management table 205.

According to the first embodiment of the present invention, in case an IP datagram of a reassembling process that is already completed or timed out is received, by not conducting the reassembling process of the aforementioned IP datagram the following effects is obtained.

Allocation of excessive resources is avoided, and waiting for the resources is avoided. Because of this, performance decrease can be prevented and system cost while constructing the system can be reduced.

### The Second Embodiment

Next, while refereeing to the figures, the second embodiment according to the present invention is explained. The only difference in second embodiment is the difference in IP datagram receiving behavior compared to the first embodiment; the rest is equal to the operations of the first embodiment.

Here, the architecture of protocol processing apparatus according to the second embodiment is equal to that of the first embodiment, thus, the explanation is omitted. Also, the information used in the reassembling process is equal to that of the first embodiment which is been explained using FIG. 2≠FIG. 5, thus, the explanation is omitted.

Moreover, reassembling initialization process, normal reassembling process and reassembling ending process is equal to that of the first embodiment which is been explained using FIG. 6≠FIG. 8, thus, the explanation is omitted.

<Reassembling Process of the Second Embodiment>

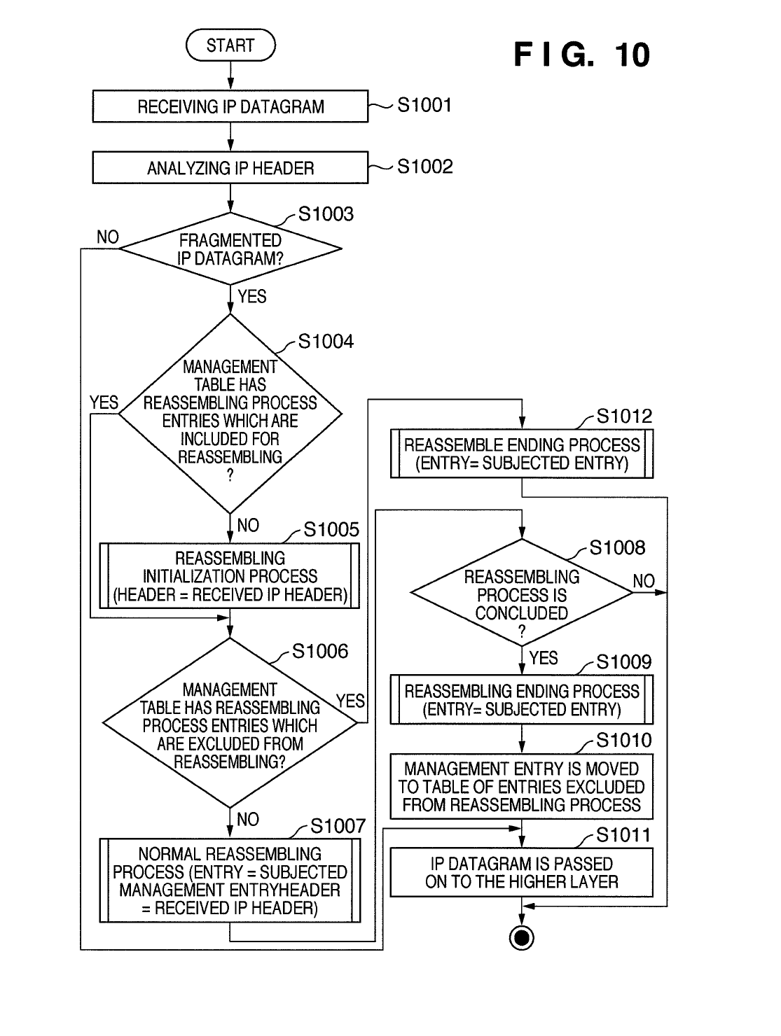

Here, the IP datagram receiving process according to the second embodiment is explained using FIG. 10. The execution of this process is triggered at CPU 101 by the received IP datagram.

FIG. 10 is a flowchart that represents the IP datagram receiving process according to the second embodiment. Since the process-flow of step S1001≠S1003 is equal to steps of S901≠S903 of the first embodiment represented in FIG. 9. Therefore, the explanation is omitted.

Next, in step S1004, reassembling process management table 202 is searched, and it is verified whether there is a management entry that matches to the received—IP header. This verification process is equal to that of the first embodiment, thus, detailed explanation is omitted.

Here, in case there is no management entry in the reassembling process management table 202 that matches the received IP datagram, the process-flow proceeds to step S1005 and executes reassembling initialization process (FIG. 6). At this time, the received header is passed to the argument Header.

Then, after executing the reassembling initialization process (FIG. 6), the process-flow proceeds to step S1006.

On one hand, in case there is a matching management entry to received IP datagram in step S1004, without executing the reassembling process (FIG. 6), the process-flow proceeds to step S1006. In step S1006, non-reassembling process management table 205 is searched, and it is verified whether there is a management entry that matches to the received—IP header. This verification process is equal to that of the first embodiment, thus, detailed explanation is omitted.

Here, in case there is no management entry in the non-reassembling process management table 205 that matches the received IP datagram, it indicates that received IP datagram is not subjected to the reassembling process. In this case, without conducting reassembling, the process-flow proceeds to step S1012, after reassembling ending process (FIG. 9) is executed, and completes the IP datagram receiving procedure.

In other words, in the first embodiment for ones which does not start reassembling process, in the second embodiment once reassembling is started, in case it is not subjected to reassembling, immediately conclude the reassembling process.

In general, even though it may look the first embodiment is advantageous due to fewer steps, there is a merit in second embodiment also. The merit depends on the Firmware construction. When software is newly developed it can be implemented as any manner as required, therefore the first embodiment is suitable for such developments. However, in case changing already existing software of a firmware, the above is not always true. In other words, in existing firmware header analysis and reassembling starting process is tightly connected to each other. Therefore, the alternation of the firmware is sometimes difficult.

In such a case, without alternating the header analysis and reassembling starting process, once after the reassembling process is started, stopping the reassembling processes according to the second embodiment is advantageous when alternation cost and difficulty of the firmware is considered.

Moreover, after the reassembling ending process (FIG. 9) in step S1012, aforementioned IP datagram is deleted from the received data area 201, in other words, the received IP datagram can be discarded.

In the second embodiment, the explanation is mainly on reassembling process, there may exist other processers that might be conducted when IP datagram is received. Discarding the IP datagram means that all of these processes or parts of the processes are not conducted on the aforementioned IP datagram.

Therefore, in case it is determined that the IP datagram is not subjected to reassembling process in step S1006, reassembling process is not executed on the received IP datagram, then, no controlling is conducted regarding whether to discard or not discard the aforementioned IP datagram.

On one hand, in case it is determined that the IP datagram is subjected to reassembling process in step S1006, the process-flow proceeds to step S1007. The process flow of this step S1007≠S1011 is equal to the process flow of step S907≠S911 of the first embodiment. Therefore, explanation is omitted.

Here, in first and second embodiment, it is presumed that the reassembling process is started when IP datagram is received. However, there is no necessity in triggering the start of the reassembling process by a received IP datagram. In some protocol processing apparatuses, as an example, starting the reassembling process after accumulation of IP datagram up to a certain level can be considered. The present invention is possible to be realized when receiving IP datagram is stored in the memory area 201 of RAM 103. Therefore, even architecture such as mention above is easily applicable to the present invention.

Moreover, in first and second embodiment, in case generation of memory area is failed due to insufficient memory area reservation for management entry, bit table, and reassembling buffer is not discussed above explanation. However even in such a case is not excluded from the scope of the present invention. As an example in case unable to generate, the reassembling process may be discarded at that point and IP datagram may be also discarded. Conventional protocol processing apparatus architecture allows conducting reassembling process in parallel, which as a limitation for number of parallel number. Therefore, it is not possible to conduct reassembling processing over the limitation.

Moreover, present invention is applied to the ID layer of TCP/IP protocol stack, according to the architecture of the upper TCP layer, TCP packets which has not been received within a limited time is been retransmitted. Therefore, even in case IP layer has once discarded the reassembling process, due to the retransmission request from the TCP layer, the data is resent from the sending unit.

Moreover, in first and second embodiment, the management entry assigning method in RAM 103 and releasing method is not discussed; however, it is obvious that any method can be used for assigning or releasing. As an example, in normal processing apparatus, in case of reserving a fixed length data area, reserving a predetermined number of data areas and then representing the usage status of each data area using flags etc. and then reserving and releasing the data area using these flags is conducted in many cases.

Moreover, in case of reserving a variable length data area, reserving the data area using software such as file systems is well conducted. Using any of the above methods or any other methods, reserving and releasing data area for management entry and bit table is within the scope of the present invention.

Moreover, in first and second embodiment, deleting management entry set to non-reassembling process management table 205 is not discussed in the above description. However, it is not even required to state that any method of deleting can be used for implementing the present invention. As an example, at the time management entry is registered, a timer that time out after a limited time interval can be associated with the management entry, when it is timed out the management entry is deleted.

However, the above method requires a plurality of timers for each registered management entry. To overcome this problem, after registering using the periodic timer, using a method such as deleting the management entry after predefined number of cycles, allows functioning without a plurality of timers. This, valid-time limit can be calculated based on the TTL (Time-to-Live) field of the IP header of the received IP datagram. In other words, since the TTL field represents the number of intermediate units in the communication path, the maximum delay (few tens of ms few hundreds of ms) of each intermediate unit multiplied by the TTL field value can be used as aforementioned valid-time limit.

Moreover, using a constant time as the valid-time limit can be also considered. When the valid time limit is determined using any of the above methods or other methods, the effects of the present invention can be obtain, which is the preservation of the management entry within the valid-time limit.

On the other hand, without setting a valid time limit, limiting the number of management entries in the non-reassembling process management table 205 can be considered as another method. In other words, when the number of recorded management entries exceeds the allowed number of management entries, deleting the already recorded management entries and recording new management entries can be considered as another method. In this case the method for choosing the management entries to be deleted can be conducted by methods such as LRU (Least Recently Used) and FIFO (First-In First-Out). Again, by using any other method, in case at least one management entry is preserved, the effects of the present invention can be obtained.

Moreover, in first and second apparatus, as a method of using the management entry recorded in the non-reassembling process management table, a method is explained, which does not conduct reassembling process when source address, destination address, and identification are matched. However, determination of received IP datagram is reassembled or not may be conducted by other methods.

Moreover, in first and second embodiment, a method is explained that handles the IP datagram that completed the reassembling process and the IP datagram that timed out equally. However, these IP datagram types may be managed separately. As an example, in case of the timed out reassembling processes, if the source address has the same value it may be a DoS attack which drains the hardware resources.

In such a case, a method that construct special management entry table can be considered as a management entry table that only looks at the source IP address to determine whether reassembling process should be conducted or not.

Moreover, as an example, in case the number of received IP datagram exceeds a predefined value that match a management entry which is been timed out at reassembling process, it can be considered that communication path and source unit are causing the delay in arrival time. In such a case, a method can be considered that extending the time out time by a predetermined time interval of the reassembling initialization process, while making the probability of completing the reassembling process high.

Moreover, as an example, in case no matching IP datagram to the management entry with completed reassembling process is received, and in case the source address of the received IP datagram is the same, it can be assumed that occurrence of replicated packets arriving with a delay is less likely.

In such a condition, a method may be considered such that after reassembling processing is completed the aforementioned management entry is not recorded which leads to saving of memory resources.

As above, by conducting some sort of learning using number of matching, probability, timing, matching contents and etc. of the non-reassembling process management entry information, tuning is conducted on the determination method of whether IP datagram is subjected to the reassembling process or not, reassembling timer and etc.

Therefore, fine tuning of the management is possible, better efficiency of the total network management process can be expected.

Next, compliments of the first and second embodiment will be explained. The compliments are implemented by combing with first and second embodiment, therefore only the difference parts are explained. Aforementioned compliments explain the details of the matching condition of management entry within non-reassembling process management table 205 and preserving period and discarding conditions of the management entry.

First, matching conditions is been explained. There are two matching condition that determined whether or not management entry in nonreassembling process management table 205 matches with a arrived IP datagram. The first matching condition is the matching all three of source address, destination address and identification. In this matching condition, the IP datagram that has completed reassembling process or IP datagram that are timed out are only determined as IP datagram that is not subjected to reassembling process. On the other hand, in the second matching condition, only source address and destination address is been matched. In this matching condition, the IP datagram that has completed reassembling process or all the fragmented IP datagram received from a client that has timed out are determined as not subjected to reassembling process. Above two matching condition are called IP datagram-matching condition and Client-matching condition respectively.

High effectiveness can be expected by using these two matching conditions according to the situation. As an example, matching conditions is applied to the management entry added when the reassembling process is completed. In case reassembling process is completed, IP datagram that should be determined as IP datagram which are not undergoing the reassembling process is the ID datagram created by replication or regeneration on the communication path. These IP datagram can be identified by the IP datagram-matching condition. On the other hand, reassembling process has been timed out, ID datagram—matching condition and client matching condition is separately used. First a threshold value is set based on the number of time outs, frequency of time out, and etc. from the same client, then until this threshold is exceeded the ID datagram—matching condition is been used, after the threshold value is passed the client—matching condition is been used. As an example, in case periods larger than predefined value is created, communication itself having some sort of problem or possibility of DoS attack can be considered.

Next preserving time period and discarding condition is been explained. Similar to previously mentioned case of matching conditions, high effectiveness can be expected from separately using preserving time period and discarding conditions in management entry added in case of reassembling process is completed and management entry is added in case reassembling process is timed out. As an example, in case of management entry added when the reassembling process is completed, time to live (TTL) of IP datagram is set as the preserving period, passing this time limit is considered as discarding condition. In case reassembling process is completed, IP datagram that should be determined as IP datagram which are not undergoing the reassembling process is the IP datagram created by replication or regeneration on the communication path. These datagram do not arrive after the TTL (time to live). Moreover, in case reassembling process is timed out, previously mentioned matching condition is executed and preserving time period and discarding conditions are updated. In other words, first a threshold value is set based on the number of time outs, frequency of time out, and etc. from the same client, then until this threshold is exceeded the time to live (TTL) is been used as the preserving time period, when the time to live value is passed it is considered to be the discarding condition. On the other hand, after passing the preserving time period, preserving time period is set as unlimited, the discarding condition is set as not receiving packet from the subjected client within predefined time interval. By setting as above, in case there is a problem in communication or in case of DoS attack which conducted for system resource draining, preventing the reassembling process resource draining can be conducted.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiments). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2008-187913 filed Jul. 18, 2008 and 2009-126822 filed May 26, 2009, which are hereby incorporated by reference herein in their entirety.

What is claimed is:

1. A network process apparatus comprising:
a processing unit that receives a fragmented IP datagram to perform a reassembling process of the received IP datagram; and
a holding unit that holds information for specifying the IP datagram which is not subjected to the reassembling process,
wherein the processing unit does not perform reassembling process of the IP datagram specified by the information held in the holding unit.

2. The apparatus according to claim 1, wherein the holding unit holds the information for specifying the IP datagram in which the reassembling process is completed by the processing unit.

3. The apparatus according to claim 1, wherein the holding unit holds the information for specifying the IP datagram in which reassembling process has not been completed within a predetermined time.

4. The apparatus according to claim 1, wherein the holding unit holds the information for specifying a source client that transmits the IP datagram in which the reassembling process is completed by the processing unit.

5. The apparatus according to claim 1, wherein the holding unit holds the information for specifying a source client that transmits the IP datagram in which reassembling process has not been completed within a predetermined time.

6. The apparatus according to claim 1, wherein, after starting the reassembling process, when the processing unit receives an IP datagram specified by the information held in the holding unit, the processing unit terminates the started reassembling process without performing the reassembling process of the received IP datagram.

7. The apparatus according to claim 1, wherein the processing unit discards the IP datagram in which the reassembling process is not performed.

8. The apparatus according to claim 1, wherein the processing unit has at least one of a reassembling buffer for storing the fragmented IP datagram, a bit map table that manages the arriving state of the IP datagram, and a reassembling timer that calculates a time-out time of the reassembling process.

9. The apparatus according to claim 1, further comprising a discarding unit that discards the information held in the holding unit in a case where the time limit of the information is passed.

10. The apparatus according to claim 1, further comprising:
a setting unit that sets the discarding conditions of the information held in the holding unit; and
a discarding unit that discards the information in which the conditions set by the setting unit is satisfied.

11. A processing method of a network processing apparatus comprising:
receiving a fragmented IP datagram to perform reassembling process of the received IP datagram, and
holding information for specifying the IP datagram in which the reassembling process is not performed,
wherein, in a case where an IP datagram specified by the information held in the holding step is received, the reassembling process of the IP datagram is not performed.

12. A computer readable recording medium, which has recorded a program for causing a computer to execute a processing method of a network processing apparatus set forth in claim 11.
